(19) United States
(12) Patent Application Publication
(10) Pub. No.: US 2013/0173461 A1
(43) Pub. Date: Jul. 4, 2013

(54) Payment System for Wearable or Implantable Sensor Data

(71) Applicant: James Alexander Levy, San Diego, CA (US)

(72) Inventor: James Alexander Levy, San Diego, CA (US)

(21) Appl. No.: 13/733,090

(22) Filed: Jan. 2, 2013

Related U.S. Application Data
(60) Provisional application No. 61/582,390, filed on Jan. 1, 2012.

(51) Int. Cl. G06Q 20/32

(52) U.S. Cl. CPC G06Q 20/322
USPC 705/39

(57) ABSTRACT

This invention is a data collection system for collecting data from one or more sensors worn by, or implanted in, a person or from one or more sensors in the environment of the person. The data collection comprises one or more sensors equipped with a short range communication link; a mobile communication device configured to communicate through the short range communication link with the sensors, and equipped with a wide area network communication link; a server in communication through the wide area network with the mobile communication device; and a financial institution also in communication through said wide area network with said server. Sensor data is transmitted from the sensors to the mobile communication device, where it is processed and then retransmitted to the server, and used to calculate a payment as a function of a business agreement. The financial institution executes the payment.

This invention claims the priority benefit of US provisional application No. 61,582,390 titled “Payment System for Wearable or Implantable Sensor Data. Applicant claims priority pursuant to 35 U.S.C. Par 119(e)(i).

### FIELD OF THE INVENTION

The present invention relates to personal wearable and implantable sensor devices that can track movement, and may also track and measure physiological and personal environmental data. This invention also relates to business agreements wherein payments are made to test subjects, volunteers, contractors or employees, or other such participants based on such data.

### BACKGROUND

Time is often used as a mechanism for determining how much is owed for a particular service. For example, lawyers tend to bill clients by the hour or fractions of an hour.

For certain tasks such as physical labor, the payment owed could incorporate the physical exertion or activity of the worker, instead of being based only on time spent working

Time is an objective and easily measurable standard, while activity-based standards such as “number of steps taken” or “number of calories burned” have not traditionally been easily measured with accuracy and objectivity.

This is now changing with the availability of retail devices containing wearable sensors that automatically retrieve biometric information from a user. These devices often network with computers via Wi-Fi, Bluetooth, or other types of connections to deliver this biometric data to a client application or a system on a remote server.

With the addition of a system to convert biometric information into payment invoice values, these devices could be used to establish a model where contracted workers can be paid per step taken or calorie burned.

Biometric information is also valuable in the context of medical, pharmaceutical and advertising research. There is a need for a mechanism for hiring test subjects and paying them for access to their vital signs after testing a product.

Further features, aspects, and advantages of the present invention over the prior art will be more fully understood when considered with respect to the following detailed description and claims.

### BRIEF DESCRIPTION OF THE DRAWINGS

FIG. 1 illustrates the main components in the invention. They comprise one or more biometric sensor and near environmental sensor and a mobile communication device accessing a server through the Internet via a Cell network or a Local Area Network. The server communicates with a financial institution that receives instruction from the server regarding payment to be made and executes these instructions.

FIG. 2 provides a flow diagram of the process involved in this invention: making a business agreement with the sensor carriers, collecting sensor data, evaluating the data, calculating payments and making payments.

### SUMMARY OF THE INVENTION

This invention includes the software and hardware required to generate and collect biometric data obtained from sensors worn by, or implanted in, test subjects or volunteers. The invention also includes a business agreement according to which the test subjects or volunteers are paid for assisting in the collection of the sensor data. In general these sensors can measure any physical or chemical parameter in the immediate environment of the test subject.

In the immediate environment of the test subject, sensors could detect sound, light, temperature, pressure, electromagnetic radiation, ionizing radiation, chemical agents including odors, and biological agents.

Sensors placed on the test subject could non-invasively measure perspiration, skin conductivity, skin temperature, breathing rate, coughing, heart rate, EEG, EKG, motion (for example by means of accelerometers worn on different parts of the body), exhaled air chemical composition and odor. Sensors near the anus could also monitor flatulence as an indication of performance for the digestive process.

Sensors implanted within the test subject could monitor blood and lymph chemistry, and the operation of different organs such as the brain (implanted EEG) or the digestive system (by means for example of swallowed electronic pills located or traveling along the gastro-intestinal tract).

The range of biometric or environmental information that could be collected is obviously not limited to the ones listed above. It covers any physical or chemical information that can be collected from the human body and from its immediate environment.

This invention is applicable to many situations in which live biometric data needs to be collected from paid test subjects. These applications include:
1. Pharmacological trials to evaluate the effect of new drugs.
2. Medical trials for assessing biometric impact of medical treatments.
3. Advertising trials to monitor biometric effects of advertising.
4. Marketing surveys that monitor biometric variations between people and correlate these variations to potential new products.
5. Employment monitoring for assessing employee activities.
6. Weight reduction programs to evaluate the amount of exercise performed by a person. For instance, raw movement and pulse data may be converted into an estimate for how many calories have been burned.
7. Physical fitness contests wherein participants compete for a prize given to the one who achieves the best fitness level as defined a-priori by a measure of biometric data collected by wearable or implantable sensors.
8. Wagering on other peoples physical fitness levels as defined a-priori by a measure of biometric data collected by wearable or implantable sensors.

### DETAILED DESCRIPTION

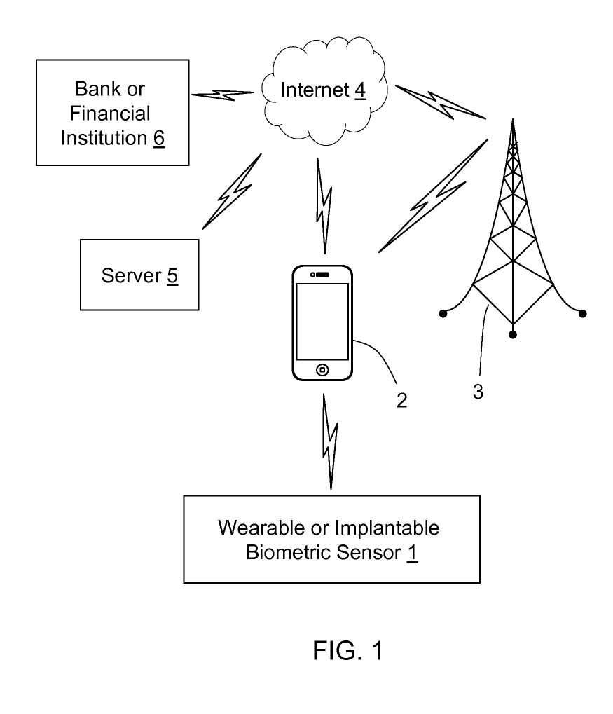

The invention is depicted in FIG. 1. It comprises the following:
1. One or more sensors 1 that monitor the movements, physiology or the near-environment (as monitored by implantable or wearable sensors) of a person.
2. A mobile communication device in communication with the sensors through a short range link such as Bluetooth or Zigbee or a physical connection such as an audio jack. The mobile communication device is in also in contact with a Wide Area Network such as the Internet, by means of cell communication or by means of Local Area Network.
3. A server that receives and processes information collected by the mobile communication device and generates payment information.
4. A financial institution that receives instruction from the server regarding payment to be made and executes these instructions.
5. Potential use of software with a graphical user interface allowing sensor carriers and additional parties to view sensor measurements or derived results and create or manage related business arrangements.

As shown in FIG. 1 the biometric data is sent from the sensor via a short-range networked or physical connection such as Bluetooth® to a computing and communication device such as the user's mobile communication device (e.g., smartphone or personal assistant). In some cases, this data may be continuously streamed from the sensor device to the computing device. Depending on the data processing requirement, the data could be processed in the mobile communication device or sent for further processing to a server connected to the mobile communication device.

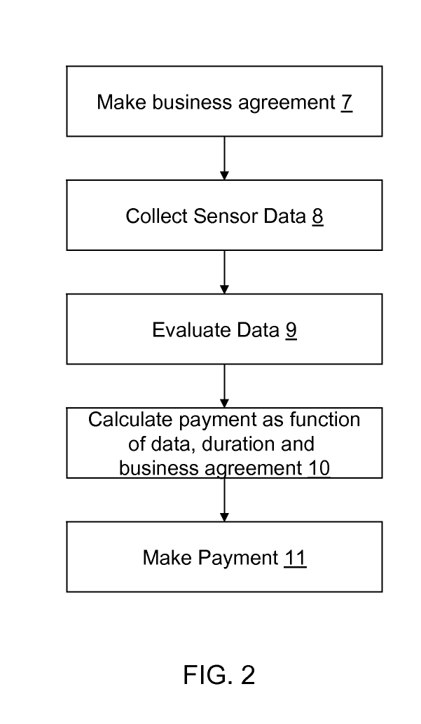

As shown in FIG. 2 processing comprises making a business agreement 7 with the carrier of the sensors, collecting 8 the sensor data, evaluating 9 the sensor data, calculating 10 a payment as a function of the data, the duration of data collection and of the business agreement, and making a payment 11 to the person carrying the sensors or to a third party involved in the business agreement.

### Example 1

Exercise Incentive System. The person wears a sensor device that measures movement, body heat and sweat levels, and other data associated with physical exercise. This data is transmitted to a server where an invoice is calculated as a payment to the person for having exercised. For example, one dollar or one dollar worth of consumption credit could be paid for each one hundred calories estimated to have been burned. The payment may come from the person wearing the sensor or from a sponsor. Metrics related to exercise such as the number of calories burned can be determined by an algorithm linking the number of calories to the measurements made by the sensor. These sensors may include accelerometers, optical blood flow sensors, skin conductivity meters, and thermometers.

### Example 2

Employee Monitoring System. An employee, consultant or contractor carries an accelerometer that measures acceleration generated during the performance of his work. Acceleration data is transmitted to a server where it is used by an algorithm to calculate the total number of steps taken and uses that number as a measure of the amount of calories burnt and of work performed. The algorithm then calculates an invoice as a payment to the employee, consultant or contractor for having performed the work. This example is applicable to tasks such as dog walking, delivering mail, waitressing etc.

### Example 3

Group Fitness Contest. A group of friends enter a fitness contest or wager in which the goal is to achieve exercise or health goals such as improved weight, heart rate or blood pressure. Movement and physiological data as measured by one or more sensors carried by contest participants, is used to determine how much exercise the wearer has performed. Sensor data is transmitted to a server where it is processed and the winner is determined. Prize money or consumption credit generated, for example, from contest entry fee or from sponsor's donations, is then disbursed to the winner or to the contestants according to a-priori arrangements incorporating their performance in the contest. A variation on this theme involves third parties betting on the performance of the individual sensor carriers or the aggregated performance of multiple sensor carriers. After data is collected and evaluated, payments are disbursed according to the betting odds established at betting time.

### Example 4

Pharmaceutical Testing Application. A pharmaceutical company hires elderly test subjects suffering from arthritis to determine the effect of a new drug on their mobility. Test subjects are required to wear sensors such as accelerometers to evaluate their movements and they are paid as long as they wear them. Accelerometer data is collected and sent to a company server where it is processed to determine the effectiveness of the drug and to calculate a payment for the test subjects.

### Example 5

Medical Testing of Blood Chemical. A research hospital pays volunteers willing to follow a new treatment for a particular disease. The volunteers are implanted with a blood chemical analysis device which wirelessly transmits blood chemical information to a server using a mobile communication device as a relay station. An algorithm located at the server records and correlates information from all volunteers and calculates a payment to the volunteers as a function of their performance and time spent on the test.

### Example 6

Medical Epidemiological Testing. Volunteers across the US are paid by a government agency to allow the monitoring of their health for the purpose of epidemiological study. They are required to wear sensors that measure their temperature and their breathing pattern (coughing). Sensor data is then sent to a server administered by the agency and is processed to evaluate the volunteer's health. An algorithm then processes the data to determine the spread of disease across the US. Volunteers are paid as a function of their wearing of the sensors.

### Example 7

Marketing Shoes. A marketing company pays test subjects for trying a new wearable product (shoes, for example). Accelerometers are attached to the product to measure how often it is used by the participants. Accelerometer data is sent to a server to record the amount of time each subject uses the product and to pay the subjects accordingly.

### Example 8

Advertising of New Products with Hand-Held Signs. An advertising company pays employees to manipulate hand-held signs pointing to the location of a store or of a sale. Accelerometers are mounted on the signs that indicate how vigorously the signs are rotated, flipped-flopped etc. Accelerometer data is then sent to a server where a payment is calculated for each employee.

### Example 9

Detection of attacks by chemical, biological or radiological agents. A government agency is paying people for wearing sensors sensitive to chemical, biological or radiological weapons. Each person wears one or several sensors that monitor the person's environment and/or the person state of health. Sensor data is transmitted to a mobile communication system which operates as a relay and re-transmits the data to a server that correlates all the information to detect the occurrence of a chemical, biological or radiological attack. Payments are calculated and disbursed to the sensor wearer according to an a-priori business agreement.

Sensors may include physiological sensors such as but not limited to, blood chemistry sensors, glucose, physiological temperature, breathing, heart rate variability, (HRV), electro-cardiogram (EKG), electro-encephalogram (EEG) or oximeter.

Sensors may also include weather sensors configured to measure light, humidity, temperature or pressure.

Sensors may also include navigation sensors such as, but not limited to, accelerometers, velocity sensors, position (e.g., GPS and laser ranging) or orientation or azimuth sensors (e.g., magnetic compass or gyro-compass).

Sensors may also include movement sensors such as, but not limited to, accelerometers, tilt angle sensors or orientation or azimuth sensors (e.g., magnetic compass or gyro-compass).

Sensors may also be configured to be sensitive to chemical agents, biological agents, radioactivity, nuclear detonation or electromagnetic radiation.

Sensors may also include sound sensors (e.g., microphones).

Sensors may also include video sensors (e.g., camcorder, webcam).

The business contract may include a weight loss program.

The business contract may include the monitoring of employees or contractors.

The business contract may include a drug testing program.

The business contract may include monitoring of a medical treatment.

The business contract may include an epidemiological study.

The business contract may include monitoring a product marketing study.

The business contract may include monitoring of advertising.

The business contract may include monitoring of the environment for attacks by chemical, biological, radiological, nuclear or electromagnetic pulse weapons.

The business contract may include monitoring of environmental audio data.

The business contract may include monitoring of environmental video data.

The business contract may include monitoring of environmental weather.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

### REFERENCES

U.S. Pat. No. 7.982,904 by Silverbrook, et al, titled “Mobile telecommunications device for printing a competition form.”

I claim:

1. A data collection system comprising:
a. at least one sensor configured to be worn by, or implanted in, a person, said at least one sensor equipped with a short range communication link;
b. a mobile communication device configured to communicate through said short range communication link with said at least one sensors, and also equipped with a wide area network communication link;
c. a server in communication through said wide area network with said mobile communication device; and
d. a financial institution also in communication through said wide area network with said server;
wherein said person is the subject of a business agreement and furthermore wherein said data is transmitted from said sensor to said mobile communication device, and said data is processed by said mobile communication device and said processed data is further transmitted to said server, and used to calculate a payment as a function of said business agreement.

2. The data collection system of claim 1 wherein said at least one sensors include at least one physiological sensor.

3. The data collection system of claim 1 wherein said at least one sensor include at least one weather sensor.

4. The data collection system of claim 1 wherein said at least one sensor include at least one navigation sensor.

5. The data collection system of claim 1 wherein said at least one sensor include at least one movement sensor.

6. The data collection system of claim 1 wherein said at least one sensor is configured to be sensitive to chemical agents, biological agents, radioactivity, nuclear detonation or electromagnetic radiation.

7. The data collection system of claim 1 wherein said at least one sensor is a microphone.

8. The data collection system of claim 1 wherein said at least one sensor is a video sensor.

9. The data collection system of claim 1 wherein said business contract includes a weight loss program.

10. The data collection system of claim 1 wherein said business contract includes monitoring of employees or contractors.

11. The data collection system of claim 1 wherein said business contract includes a drug testing program.

12. The data collection system of claim 1 wherein said business contract includes monitoring of a medical treatment.

13. The data collection system of claim 1 wherein said business contract includes an epidemiological study.

14. The data collection system of claim 1 wherein said business contract includes a product marketing study.

15. The data collection system of claim 1 wherein said business contract includes the monitoring of advertising.

16. The data collection system of claim 1 wherein said business contract includes the monitoring of the environment for attacks by chemical, biological, radiological, nuclear or electromagnetic pulse weapons.

17. The data collection system of claim 1 wherein said business contract includes the monitoring of environmental audio data.

18. The data collection system of claim 1 wherein said business contract includes the monitoring of environmental video data.

19. The data collection system of claim 1 wherein said business contract includes monitoring of environmental weather.
